(19) United States
(12) Patent Application Publication
(10) Pub. No.: US 2007/0288127 A1
(43) Pub. Date: Dec. 13, 2007

(54) METHODS AND SYSTEMS FOR REMOTELY CONTROLLING A VEHICLE

(76) Inventors: Shah Haq, Naperville, IL (US); Dinesh K. Jindal, Naperville, IL (US)

Correspondence Address: DUFT BORNSEN & FISHMAN, LLP, 1526 SPRUCE STREET, SUITE 302, BOULDER, CO, 80302, US

(21) Appl. No.: 11/423,204

(22) Filed: Jun. 9, 2006

(51) Int. Cl. G06F 17/00

(52) U.S. Cl. 701/2

(57) ABSTRACT

Systems and methods for a law enforcement entity to remotely control a vehicle are provided. One embodiment of the invention includes a system adapted to remotely control a vehicle. The system comprises an authorization system adapted to receive a request for remotely controlling the vehicle from a law enforcement entity, to identify at least one vehicle control parameter authorizing the law enforcement entity to control at least one vehicle movement function of the vehicle, and to transmit an authorization for remotely controlling the vehicle and at least one vehicle control parameter responsive to the request. The system further comprises a control system adapted to receive the authorization and the at least one vehicle control parameter from the authorization system and transmit a control signal to the vehicle that controls the at least one vehicle movement function of the vehicle authorized by the at least one vehicle control parameter.

### BACKGROUND

1. Field of the Invention

The invention relates generally to the field of communications, and particularly to systems and methods for a law enforcement entity to remotely control a vehicle.

2. Statement of the Problem

In cases where an individual has committed a crime and is attempting to escape via a vehicle, the police have a limited number of solutions to apprehend the suspect. Typically, the police will initiate a car chase, and attempt to stop the vehicle and apprehend the suspect. If the police are unsuccessful, the suspect will escape from the police. In other scenarios, drivers may have temporary or permanent mental or physical health problems, which result in the individual not realizing their surroundings or being unable to control their vehicle properly. In these situations, the police also have very few solutions to stop or control the vehicle. Again the police must physically stop the vehicle or wait until the driver actually stops, either by their own choice or by some physical vehicle problem (i.e., the vehicle crashes or runs out of fuel).

Conducting car chases can be dangerous for bystanders, suspects and police. In this regard most car chases occur at high speeds in excess of the speed limit, and involve dangerous driving by both suspects and the police. When suspects are unwilling to pull over, police often make attempts to immobilize the vehicle to end the car chase. In hostage situations, police must take into account the safety of the hostages when attempting to immobilize a vehicle or suspect. Attempts to immobilize vehicles often include ramming the vehicle by the police, boxing the vehicle in, and setting up roadblocks and spike strips. All three methods put suspects, the police and bystanders at risk. At high speeds, attempts to immobilize a vehicle can result in the driver losing control. In other situations the vehicle flips over or strikes other objects, such as people, other vehicles, or buildings. In addition to external risks, immobilization attempts may also injure the suspect and damage police vehicles. In cases where the vehicle is stolen, it is desirable to limit damage to the vehicle done by police in attempting to apprehend a suspect.

Presently, there are limited choices for remotely immobilizing a vehicle. Present technology only allows a vehicle to be remotely immobilized by letting the air out the tires using an externally-mounted device on one or more tires. Not only are such devices dangerous to use, but the tire must be re-inflated before the vehicle can be driven again. Also, the device is externally mounted, which allows it to be easily removed by thieves and/or the vehicle driver. Other technologies for remotely controlling a vehicle by the intended operator, such as Hollywood stunt vehicles and remote controlled airplanes, are currently available. These types of technologies are unsafe for highway use if vehicles can be remotely controlled by unauthorized users. For example, it is not desirable to implement a system which any individuals are allowed to remotely control the vehicle. Additionally, such a system may increase vehicle thefts, carjacking and kidnapping incidents, and may open the door for widespread havoc on the streets.

### SUMMARY OF THE INVENTION

The invention solves the above and other problems with systems and methods for a law enforcement entity to remotely control a vehicle so that the dangers of high speed chases are minimized or eliminated. Using the systems and methods, law enforcement entities request authorization to remotely control a vehicle from a central agency. Once the authorization has been granted, the law enforcement entities have remote access to a vehicle to control the components onboard the vehicle, such as steering, forward/reverse movements or the ability to limit the speed of the vehicle, or to completely immobilize the vehicle. In addition, significant expenditures in time and resources by police to apprehend suspects may be eliminated as well as the risks involved by individuals without proper authority from remotely controlling the motion of a vehicle. For instance, if a high speed chase commences on a busy freeway, a police officer can request authorization to stop the vehicle. Once authorization is granted, the police officer can remotely stop the vehicle and apprehend the suspect without the use of roadblocks, spike strips or ramming the suspect's vehicle.

One embodiment of the invention includes a system adapted to remotely control a vehicle. The system comprises an authorization system adapted to receive a request for remotely controlling the vehicle from a law enforcement entity, to identify at least one vehicle control parameter authorizing the law enforcement entity to control at least one vehicle movement function of the vehicle, and to transmit an authorization for remotely controlling the vehicle and the at least one vehicle control parameter. The system further comprises a control system adapted to receive the authorization and the at least one vehicle control parameter from the authorization system and transmit a control signal to the vehicle that controls the at least one vehicle movement function of the vehicle authorized by the at least one vehicle control parameter. Vehicle movement functions may include changing the speed of the vehicle, stopping the vehicle, steering the vehicle, etc.

The system advantageously allows law enforcement entities to remotely control a vehicle, and provides security to keep unauthorized individuals from remotely controlling vehicles. Additionally, the system provides law enforcement entities the ability to remotely control a vehicle under necessary circumstances, reducing the possibility for harassment and other privacy concerns.

Another embodiment of the invention includes a method of remotely controlling a vehicle. The method includes the steps of receiving a request in an authorization system for remotely controlling the vehicle from a law enforcement entity, and identifying at least one vehicle control parameter authorizing the law enforcement entity to control at least one vehicle movement function of the vehicle. The method further includes the step of transmitting an authorization for remotely controlling the vehicle and the at least one vehicle control parameter from the authorization system to a control system of the law enforcement entity. The authorization authorizes the law enforcement entity, through the control system, to remotely control the vehicle. The method further comprises the step of transmitting a control signal to the vehicle from the control system that controls the at least one vehicle movement function of the vehicle authorized by the at least one vehicle control parameter. The invention may include other exemplary embodiments described below.

### DESCRIPTION OF THE DRAWINGS

The same reference number represents the same element or similar element on all drawings.

FIG. 1 illustrates a system for remotely controlling a vehicle in an exemplary embodiment of the invention.

FIG. 2 is a flow chart illustrating a method of remotely controlling a vehicle in an exemplary embodiment of the invention.

FIG. 3 illustrates another system for remotely controlling a vehicle in an exemplary embodiment of the invention.

FIG. 4 is a flow chart illustrating another method of remotely controlling a vehicle in an exemplary embodiment of the invention

### DETAILED DESCRIPTION OF THE INVENTION

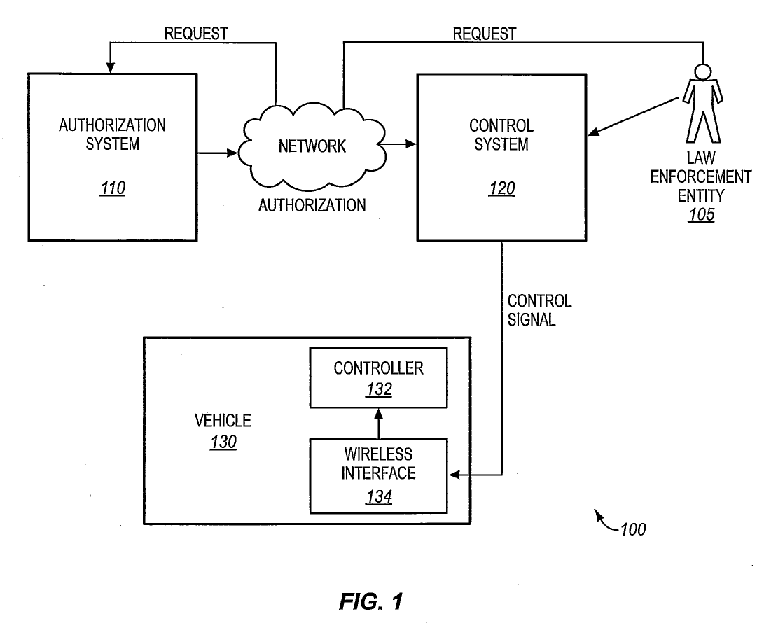

FIGS. 1-4 and the following description depict specific exemplary embodiments of the invention to teach those skilled in the art how to male and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates a system 100 for remotely controlling a vehicle 130 in an exemplary embodiment of the invention. The system 100 comprises an authorization system 110 and a control system 120. The authorization system 110 and the control system 120 may communicate through a network, such as an IP network, an internet network, a telephony network, etc. The authorization system 110 comprises any system or server that authorizes a law enforcement entity 105 to remotely control a vehicle 130. The authorization system 110 may be adapted to receive requests from a plurality of law enforcement entities 105 and a plurality of control systems 120 over the network. The control system 120 comprises any wireless system or device that controls a vehicle responsive to an input by a law enforcement entity 105. Depending on the functions of the vehicle 130 to be controlled, the control system 120 may be installed in a police vehicle operated by the law enforcement entity 105 that is following the vehicle 130. The control system 120 may be a specialized system mimicking the controls of a vehicle 130 so that the law enforcement entity 105 can remotely control the vehicle 130 as though the law enforcement entity were actually driving the vehicle 130. The control system 120 may alternatively comprise a laptop computer with a GUI interface or any other interface for entering control commands.

To prevent misuse by local law enforcement officials and other individuals, the authorization system 110 is operated by a central agency such as the Federal Bureau of Investigation (FBI) or the Department of Homeland Security. Other law enforcement entities, such as local police departments, request authorization to remotely control the vehicle 130 through the central agency. The law enforcement entity 105 may be a distinct agency from the central agency. For example, the law enforcement entity 105 may comprise the Highway Patrol of a particular state, and the central agency may comprise a department within the FBI. Depending on the situation that the vehicle 130 is involved in, the central agency may authorize the law enforcement entity 105 to remotely control the vehicle 130. The authorization process from the central agency is similar to the warrant process used by the police. The law enforcement entity 105 provides information to the authorization system 110, and the authorization system determines whether authorization for remotely controlling the vehicle 130 is appropriate under the circumstances. The authorization system 110 acts a check on local police abuse, and keeps confidential information needed to operate vehicles remotely in a central repository for safety reasons.

The vehicle 130 comprises equipment installed either at the time of manufacture or as an after market product that allows the control system 120 to remotely control the vehicle 130. The vehicle 130 to be remotely controlled may include a controller 132 in signal communication with the components of the vehicle 130, such as a steering mechanism, a braking system, an engine and a transmission system, and adapted to control the functionality of these components. One or more vehicle movement function of the vehicle 130 may change in response to control signal received from the control system 120. A vehicle movement function is a movement of the vehicle 130 in relation to the surroundings of the vehicle 130 based on the control signal received by the vehicle 130 from the control system 120. For example, a vehicle movement function may include steering the vehicle 130 left or right, accelerating the vehicle 130, decelerating the vehicle 130 or stopping the vehicle 130. For instance, if the control signal instructs the vehicle 130 to slow down, the vehicle 130 slows down upon receiving the control signal.

The vehicle 130 may also comprise a wireless interface 134 adapted to receive the control signal from the control system 120. The wireless interface 134 is in signal communication with the controller 132, and adapted to provide the control signal to the controller 132. The controller 132 and wireless interface 134 may be installed in the vehicle 130 at the time of manufacture, or installed in the vehicle 130 as an after market accessory.

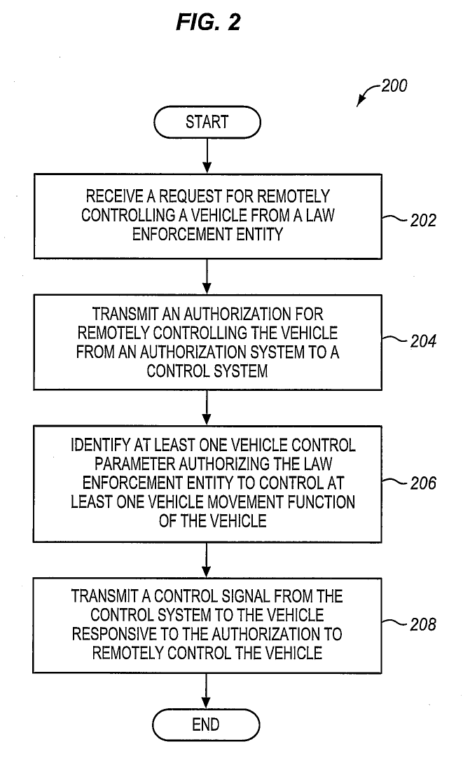

FIG. 2 is a flow chart illustrating a method 200 for remotely controlling the vehicle 130 using system 100 for the embodiment in FIG. 1. The steps of method 200 will be described with reference to FIG. 1. Method 200 may not be all inclusive, and may include other steps not shown.

In step 202, the authorization system 110 receives a request for remotely controlling the vehicle 130 from the law enforcement entity 105. A request may include information regarding the situation involving the vehicle 130. The authorization system 110 may receive the request from the law enforcement entity 105 through a network between the authorization system 110 and the control system 120, a voice phone call or radio call to an operator at the authorization system 110, through a data transfer from the control system 120 to the authorization system 110, through a graphical user interface (GUI) designed to interface with the authorization system 110 or through another means. The request may include a vehicle 130 or suspect description so that the authorization system 110 can identify the vehicle 130 to be remotely controlled by the law enforcement entity 105. Additionally, the request from the law enforcement entity 105 may include a situation description involving the vehicle 130 and the vehicle operator. The request may additionally include particular vehicle movement functions of the vehicle 130 that the law enforcement entity 105 desires to control.

In step 204, the authorization system 110 identifies one or more vehicle control parameters authorizing the law enforcement entity 105 to control at least one vehicle movement function of the vehicle. The vehicle control parameters specify the specific vehicle movement functions of the vehicle 130 that the law enforcement entity 105 may remotely control. Based on the situation description, the authorization system 110 may identify vehicle control parameters authorizing the law enforcement entity to remotely control specified vehicle movement functions of the vehicle 130.

Based upon the request, in step 206, the authorization system 110 transmits an authorization for remotely controlling the vehicle 130 authorizing the control system 120 to control at least one vehicle movement function of the vehicle 130. An authorization is one or more data packets comprising a control acknowledgment and other data, such as passwords, a directory number and vehicle identifying information necessary to remotely locate and control the vehicle 130. In addition to the authorization, the authorization system 110 also transmits to the control system 120 one or more vehicle control parameters that have been identified by the authorization system 110. The one or more vehicle control parameter authorize the law enforcement entity 105 to control at least one vehicle movement function of the vehicle 130.

The control system 120 is adapted to receive the authorization from the authorization system 110. The control system 120 is further adapted to receive an input from the law enforcement entity 105. The input from the law enforcement entity 105 specifies the vehicle movement function of the vehicle 130 to be controlled by the law enforcement entity 105. In step 208, the control system 120 transmits the control signal to the vehicle 130 that controls at least one vehicle movement function of the vehicle. The control signal is generated by the control system 120 based upon the input from the law enforcement entity 105. In response to the vehicle 130 receiving the control signal 120 from the control system 110, at least one vehicle movement function of the vehicle 130 may change. If the vehicle 130 is in close proximity to the control system 130, then the control system 130 may transmit the control signal over a peer to peer RF network.

The control system 120 may be further adapted to determine whether the input from the law enforcement entity 105 has been authorized by the authorization system 110, and generate the control signal for the vehicle 130 based upon the input. This is done by checking the input from the law enforcement entity 105 against the vehicle control parameters transmitted to the control system 120 by the authorization system 110. If the input from the law enforcement entity 105 has been authorized, then the control system 120 may transmit the control signal to the vehicle 130. Otherwise, the control signal may not be transmitted by the control system 120. For example, if the law enforcement entity 105 has only been authorized by the authorization system 110 to control the braking system, then the control system 120 may not transmit the control signal to the vehicle 130 based upon the law enforcement entity turning a steering wheel on the control system 120. Under the authorization, the law enforcement entity 105 has not been authorized to remotely control the steering mechanism of the vehicle 130, so the input may be ignored.

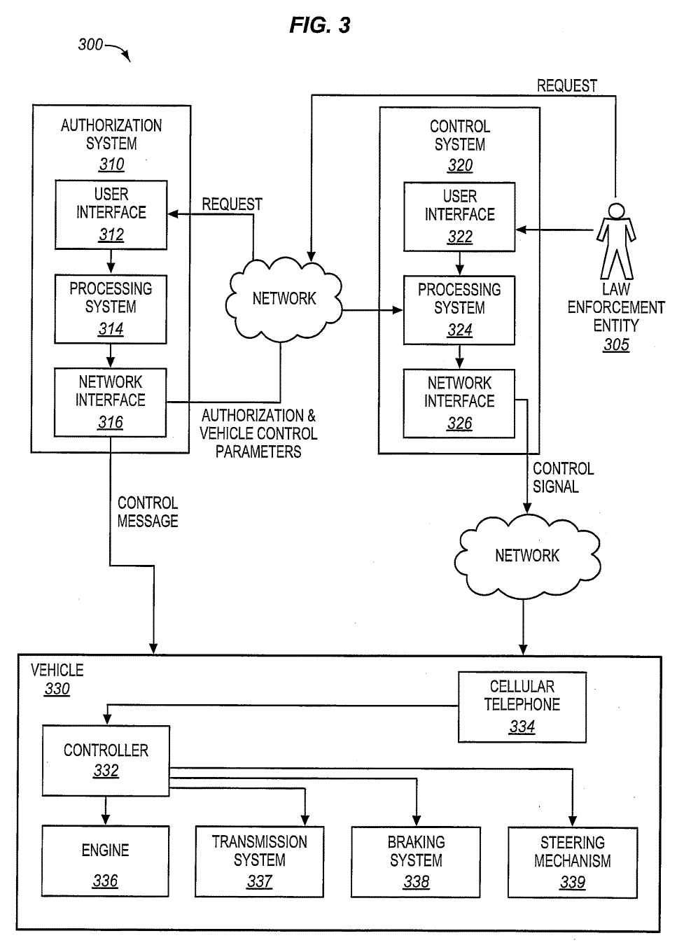

FIG. 3 illustrates a system 300 for remotely controlling a vehicle 330 in another exemplary embodiment of the invention. The system 300 comprises an authorization system 310 and a control system 320. The authorization system 310 and the control system 320 are connected by a network. The authorization system 310 further comprises a user interface 312, a processing system 314 and a network interface 316. The control system 320 further comprises a user interface 322, a processing system 324 and a network interface 326.

The user interface 312 in the authorization system 310 is provided for an operator at the authorization system 310 to interface with the authorization system 310. The user interface 312 may further provide for a law enforcement entity 305 to interface with the authorization system 310. The processing system 314 is provided in the authorization system 310 to process the request from the law enforcement entity 305 to remotely control the vehicle 330. The network interface 316 in the authorization system 310 is provided for the authorization system 310 to interface with the networks for transmitting and receiving messages from the control system 320 and the vehicle 330.

The user interface 322 in the control system 320 is provided for a law enforcement entity 305 to interface with the control system 320. The user interface 322 may further provide for the law enforcement entity 305 to interface with the control system 320 through the network. The processing system 324 is provided in the authorization system 320 to process the authorization from the authorization system 310 and generate the control signal transmitted to the vehicle 330. The network interface 326 in the control system 320 is provided for the control system 320 to interface with networks for transmitting and receiving messages from the authorization system 310 and the vehicle 330.

The illustrated embodiment in FIG. 3 also comprises a controller 332 on the vehicle 330 in signal communication with the control system 320 adapted to control at least one vehicle movement function of the vehicle 330 responsive to receiving the control signal from the control system 320. The controller 332 may be in signal communication with other components of the vehicle 330, including a braking system 338, an engine 336, a transmission system 337 and a steering mechanism 339. The engine 336 is adapted to change a speed of the vehicle 330 responsive to the control signal received from the controller 332. The steering mechanism 339 is adapted to change a direction of the vehicle 330 responsive to the control signal received from the controller 332. The braking system 338 is adapted to brake the vehicle 330 responsive to the control signal received from the controller 332. The transmission system 337 is adapted to control an output of the engine 336 responsive to the control signal received from the controller 332.

In the described embodiment in FIG. 3, each vehicle 330 manufactured includes a unique identification (UID) code stored on the vehicle 330. Additionally, older vehicles may be retrofitted with a controller 332 comprising a UID. The UID may be stored in ROM on the vehicle 330 so individuals cannot erase or change the UID for the vehicle 330. The UID may be any unique character string of any length for identifying the vehicle 330. The UID may be generated by embedding certain information regarding the vehicle 330, such as year, manufacturer, model and unique manufacturer vehicle identifier. One such format of the UID is [YYYY-MMM-TTTTT-UUUUUU], where Y is the four digit year of manufacturer, M is a four digit manufacturer identification number, T is a five digit model identification number, and U is a unique number for each vehicle built within a model year by the manufacturer. Those skilled in the art will recognize that the UID can be generated by different methods and comprised of different formats to create a different UID for each vehicle manufactured.

In the described embodiment in FIG. 3, the control system 320 may use the UID to authenticate the control system 320 to the vehicle 330. Prior to the law enforcement entity 305 transmitting a request to the authorization system 310 to remotely control the vehicle 330, only the authorization system 310 and the vehicle 330 know the vehicle's UID. The law enforcement entity 305 identifies the vehicle 330 to the authentication system 310, such as a VIN, a license plate number, the driver's identity if known, or a more general vehicle 330 description. The authentication system 310 is adapted to identify the UID for the vehicle 330, and transmit the UID to the control system 320. The control system 320 is adapted to transmit the UID in the control signal to the vehicle 330 to authenticate the control system 320 to the vehicle 330. The vehicle 330 checks the UID received from the control system 320 to determine if the UID received is the same one as stored on the vehicle 330. If the UID received from the control system 320 matches the UID stored on the vehicle 330, then the control system 320 is authenticated to the vehicle 330. If the UID received from the control system 320 does not match the UID stored on the vehicle 330, then the control system 320 is denied authentication to the vehicle 330, and the vehicle 330 will not process the control signal.

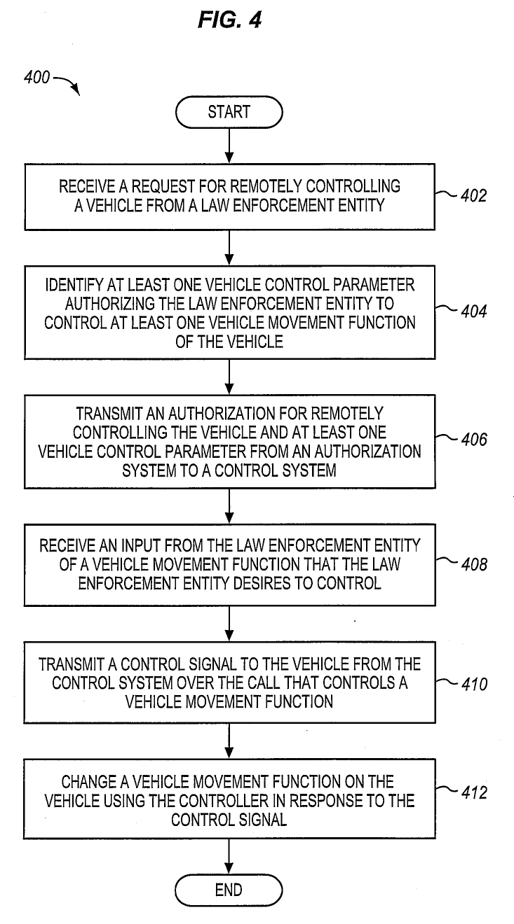

FIG. 4 is a flow chart illustrating a method 400 for remotely controlling the vehicle 330 using system 300 for the embodiment in FIG. 3. The steps of method 400 will be described with reference to FIG. 3. Method 400 may not be all inclusive, and may include other steps not shown.

In step 402, the authorization system 310 receives a request through the user interface 312 to remotely control the vehicle 330 from the law enforcement entity 305. Additionally, the authorization system 310 receives a situation description involving the vehicle 330 from the law enforcement entity 305. The situation description may comprise a code specifying the suspect's offense committed, may comprise the law enforcement entity 305 transmitting a written description of the situation through the user interface 312, etc. For example, if the situation involves a high speed chase, the situation description may specify “High speed chase on interstate—speeds over 100 MPH.”

In step 404, in response to receiving the situation description from the law enforcement entity 305, the processing system 314 of the authorization system 310 identifies one or more one vehicle control parameters authorizing the control system 320 to remotely control at least one vehicle movement function of the vehicle 330. The vehicle 330 is capable of a plurality of vehicle movement functions, such as steering, acceleration, deceleration, etc. The vehicle control parameters specify the vehicle movement functions that the law enforcement entity 305 is allowed to remotely control. For instance, the authorization system 310 may receive a situation description from the law enforcement entity 305 indicating that the vehicle 330 is involved in a high speed chase in excess of 100 MPH. The processing system 314 may determine that the control system 320 is authorized to stop the vehicle 330. In this circumstance, the vehicle control parameters may include stopping the vehicle 330.

The vehicle control parameters may be dynamically assigned depending on the situation involving the vehicle 330. In some situations, it may be desirable to allow a vehicle operator to override the control signal, either because the severity of the offense does not warrant complete remote control of the vehicle 330, or because of safety or other operating reasons. It may be safer for the vehicle operator to still have control over certain functions of the vehicle 330. The vehicle control parameters can be set for any function of the vehicle 330, including but not limited to, speed, direction, and steering. For example, a maximum speed could be imposed to avoid high speed chases in one scenario, while in another scenario it may be desirable to completely immobilize the vehicle 330 so that no car chase will continue.

In step 406, the processing system 314 transmits an authorization for remotely controlling the vehicle 330 and one or more vehicle control parameters authorizing the control system 320 to control one or more associated vehicle movement functions of the vehicle 330 responsive to the request. The vehicle movement functions may include steering, forward/reverse movements, braking, engine output, vehicle speed, etc.

In step 408, the control system 320 receives an input from the law enforcement entity 305 through user interface 322 of a vehicle movement function of the vehicle 330 that the law enforcement entity 305 desires to control.

In step 410, the control system 320 transmits a control signal to the vehicle 330 that controls one or more vehicle movement functions of the vehicle 330. The system 300 may utilize the infrastructure of an existing wireless carrier or other communications network to provide the control signal to the vehicle 330. The control system 320 may transmit the control signal over a cellular network, a local wireless network, a satellite network or a radio frequency through the network interface 326. In an embodiment where the control system 320 transmits the control signal over the cellular network, the vehicle 330 further comprises a cellular phone 334 having a directory number. Using the directory number, the control system 320 places a call to the vehicle 330 at the directory number through the cellular phone 334 and transmits the control signal to the vehicle 330. Once the vehicle 330 has been called by the control system 320, the control system 320 can further authenticate itself to the vehicle 330.

In step 412, the controller 332 changes at least one vehicle movement function of the vehicle 330 responsive to receiving the control signal from the control system 320. A controller 332 on the vehicle 330 is adapted to process the control signal and control the vehicle 330 to perform the vehicle movement functions based on the control signal.

In the described embodiment in FIG. 3, the authorization system 310 may additionally be adapted to transmit a control password for the vehicle 330 to the control system 320. The control system 320 is adapted to transmit the control password in the control signal to authenticate the control system 320 to the vehicle 330. The control password can be a string permanently saved onboard the vehicle 330 in ROM. In this instance, the control password remains static for the vehicle 330, and the control password is stored in the authentication system 310. When a request is made to the authentication system 310 by a law enforcement entity 305, the control password is transmitted to the law enforcement entity 305 or to the control system 320 for authentication with the vehicle 330.

Examples are provided to illustrate uses for the systems and methods described herein. In one example, assume that a suspect has stolen the vehicle 330 and a law enforcement entity 305 is in pursuit of the vehicle 330. A high speed car chase commences, reaching speeds in excess of 100 MPH. The law enforcement entity 305 would like to decrease the speed of the chase to a safer speed. The law enforcement entity 305 initiates a request received by the authorization system 310 to remotely control the vehicle 330 and limit the speed to 40 MPH. After the authorization system 310 transmits the authorization to the control system 320, the law enforcement entity 305 uses the control system 320 to send a control signal limiting the speed of the suspect's vehicle 330 to 40 MPH. The vehicle 330 will slow down to 40 MPH, even if the suspect presses the accelerator pedal on the vehicle 330.

In another example, assume that an elderly man enters the interstate headed the wrong direction. The man is unaware of his surroundings, and does not pull over for the law enforcement entity 305 when requested. The law enforcement entity 305 initiates a request received by the authorization system 310 to remotely control the vehicle 330. The law enforcement entity 305 requests authorization from the authorization system 310 to steer the vehicle 330 and stop the vehicle 330. After the authorization system 310 transmits authorization to the control system 320, the law enforcement entity 305 uses the control system 320 to send a control signal to the vehicle 330 to decrease the speed of the vehicle 330 to 10 MPH, steer the vehicle 330 to the shoulder of the interstate, and stop the vehicle 330.

Although specific embodiments were described herein, the scope of the invention is not limited to those specific embodiments. The scope of the invention is defined by the following claims and any equivalents thereof.

We claim:

1. A system for remotely controlling a vehicle, the system comprising:
an authorization system adapted to receive a request for remotely controlling the vehicle from a law enforcement entity, to identify at least one vehicle control parameter authorizing the law enforcement entity to control at least one vehicle movement function of the vehicle, and to transmit an authorization for remotely controlling the vehicle and the at least one vehicle control parameter; and
a control system adapted to receive the authorization and the at least one vehicle control parameter from the authorization system and transmit a control signal to the vehicle that controls the at least one vehicle movement function of the vehicle authorized by the at least one vehicle control parameter.

2. The system of claim 1 wherein the authorization system is adapted to receive a situation description involving the vehicle from the law enforcement entity, and to identify the at least one vehicle control parameter based on the situation description.

3. The system of claim 1 wherein:
the authorization system is adapted to identify a unique identification for the vehicle and transmit the unique identification to the control system; and
the control system is adapted to transmit the unique identification to the vehicle in the control signal to authenticate the control system to the vehicle.

4. The system of claim 1 wherein:
the authorization system is adapted to identity a control password for the vehicle, and to transmit the control password to the control system; and
the control system is adapted to transmit the control password to the vehicle in the control signal to authenticate the control system to the vehicle.

5. The system of claim 1 wherein the authorization system is further adapted to transmit a control message to the vehicle, wherein the control message is adapted to authenticate the control system to the vehicle.

6. The system of claim 1 wherein the control system is adapted to transmit the control signal to the vehicle over a cellular network, a local wireless network, a satellite network or a radio frequency.

7. The system of claim 1 wherein the control system is adapted to place a call to a directory number of the vehicle and provide the control signal to the vehicle over the call.

8. The system of claim 1 further comprising a controller on the vehicle in signal communication with the control system adapted to control the at least one vehicle movement function of the vehicle responsive to the control signal.

9. The system of claim 1 wherein the control system is further adapted to receive an input from the law enforcement entity specifying the at least one vehicle movement function to change on the vehicle that is used to generate the control signal to the vehicle.

10. A method for remotely controlling a vehicle, the method comprising:
receiving a request in an authorization system for remotely controlling the vehicle from a law enforcement entity;
identifying at least one vehicle control parameter authorizing the law enforcement entity to control at least one vehicle movement function of the vehicle;
transmitting an authorization for remotely controlling the vehicle and the at least one vehicle control parameter from the authorization system to a control system of the law enforcement entity; and
transmitting a control signal to the vehicle from the control system that controls the at least one vehicle movement function of the vehicle authorized by the at least one vehicle control parameter.

11. The method of claim 10 further comprising:
receiving a situation description in the authorization system involving the vehicle from the law enforcement entity; and
identifying the at least one vehicle control parameter based on the situation description.

12. The method of claim 10 further comprising:
identifying in the authorization system a unique identification for the vehicle;
transmitting the unique identification for the vehicle from the authorization system to the control system; and
transmitting the unique identification for the vehicle in the control signal to the vehicle to authenticate the control system to the vehicle.

13. The method of claim 10 further comprising:
identifying a control password for the vehicle in the authorization system;
transmitting the control password from the authorization system to the control system; and
transmitting the control password in the control signal from the control signal to the vehicle to authenticate the control system to the vehicle.

14. The method of claim 10 further comprising transmitting a control message from the authentication system to the vehicle to authenticate the control system to the vehicle.

15. The method of claim 10 wherein transmitting the control signal to the vehicle from the control system comprises transmitting the control signal over a cellular network, a local wireless network, a satellite network or a radio frequency.

16. The method of claim 10 wherein transmitting the control signal to the vehicle from the control system comprises placing a call from the control system to the vehicle at a directory number, and providing the control signal to the vehicle over the call.

17. The method of claim 10 further comprising changing the at least one vehicle movement function of the vehicle using a controller on the vehicle responsive to the control signal.

18. The method of claim 10 further comprising receiving an input from the law enforcement entity in the control system specifying at least one vehicle movement function to change on the vehicle that is used to generate the control signal to the vehicle.

19. A method for remotely controlling a vehicle, the method comprising:
receiving a request in an authorization system for remotely controlling the vehicle from a law enforcement entity;
identifying at least one vehicle control parameter authorizing the law enforcement entity to control at least one vehicle movement function of the vehicle;
identifying a unique identification for the vehicle;
transmitting an authorization for remotely controlling the vehicle and the at least one vehicle control parameter from the authorization system to a control system of the law enforcement entity;
transmitting the unique identification from the control system to the vehicle to authenticate the control system to the vehicle;
receiving an input in the control system from the law enforcement entity to remotely control the vehicle; and
transmitting a control signal from the control system to the vehicle that controls the at least one vehicle movement function of the vehicle authorized by the at least one vehicle control parameter based upon the input from the law enforcement entity.

20. The method of claim 19 wherein transmitting the control signal to the vehicle from the control system comprises placing a call from the control system to the vehicle at a directory number, and providing the control signal to the vehicle over the call.
